(19) United States
(12) Patent Application Publication
(10) Pub. No.: US 2007/0240150 A1
(43) Pub. Date: Oct. 11, 2007

(54) SIMPLIFYING INSTALLATION OF A SUITE OF SOFTWARE PRODUCTS

(75) Inventors: Jyotsna GANGWAR, Bangalore (IN); Pradeep Kumar Itharaju, Bangalore (IN); Sanghamitra BISWAS, Bangalore (IN); Bharat PALIWAL, Fremont, CA (US)

Correspondence Address: LAW FIRM OF NAREN THAPPETA, 158, PHASE ONE PALM MEADOWS, RAMAGUNDANAHALLI, AIRPORT WHITEFIELD ROAD, BANGALORE, 560043, IN

(73) Assignee: ORACLE INTERNATIONAL CORPORATION, Redwood Shores (US)

(21) Appl. No.: 11/308,125

(22) Filed: Mar. 8, 2006

(51) Int. Cl. G06F 9/445

(52) U.S. Cl. 717/174

(57) ABSTRACT

The input values/parameters required specifically for installation of each of multiple software products of a suite are received from a user up-front, and the software products are installed sequentially thereafter based on the received input values. Since all the required input values are received up-front, the installation of all the software products can continue without requiring user intervention. According to another aspect of the invention, the user inputs are stored in a secondary storage and in case the installation aborts in the middle, the uninstalled products are installed when the user initiates the installation software again.

### BACKGROUND OF THE INVENTION

1. Field of the Invention

The present invention relates generally to software installation and more specifically to a method and apparatus for simplifying installation of a suite of software products.

2. Related Art

A suite of software products generally refers to a set of products which can be operated in a common environment. For example, several databases and related applications are each implemented as a software product and executed on computer systems connected by a network. In general, each product can execute independently, possibly in a cooperating manner with other products.

Each software product needs to be installed prior to execution/operation. Installation of a software product generally refers to storing various software instructions (potentially grouped as several modules) and data parameters such that the instructions can be later executed (using the data parameters, if needed) to provide the features desired of the product.

Installation of each software product often requires that users provide various input values. The input values may specify the directory structure at which the installation is to be performed, any parameters (e.g., authentication information to logon to a database) which would be required to inter-operate with other products, and potentially various user options (e.g., specific modules/portions of the software product to be installed optionally).

In one prior approach, installation (of a suite of software products) entails inserting a medium containing the installation files into a corresponding drive (or otherwise making the installation files available, e.g., over a network), and executing the installation files corresponding to each of the software products sequentially. During such installation, a user is required to provide various input values (required for installing each software product) while the installation is in progress for the corresponding software product.

One drawback with such an approach is that users are required to monitor the progress of the installation of all of the desired products, at least to provide input values required for installation of the corresponding product. The installation may be stalled until the user provides the required input values. As a result, the total time to complete installation may unnecessarily be increased, in addition to requiring the user to monitor installation of each software product.

Alternatively, software products may be designed to be installed with a user being required to provide only the parameters, which are common to all the software products. For example (as in installation of MS-office product suite available from Microsoft), a user may specify a directory under which all of the suite of software products of interest need to be installed, and an install wrapper program may install each software product in a corresponding sub-directory of the specified directory.

However such an approach may require a user to provide additional parameters, which are specific to each software product during/prior to the installation of the corresponding software product (potentially being installed later in the sequence). Again, the user may be required to monitor the progress of installation of the software products in such a scenario, which is generally undesirable.

Therefore what is needed is a method and apparatus for simplifying installation of a suite of software products.

### BRIEF DESCRIPTION OF THE DRAWINGS

The present invention will be described with reference to the accompanying drawings briefly described below.

FIG. 1 is a block diagram of an example environment in which various aspects of the present invention can be implemented.

FIG. 2 is a flow chart illustrating the manner in which installation of suite of products can be performed according to various aspects of the present invention.

FIGS. 3-6 illustrates a graphical user interface which facilitate users to provide input values for various parameters for installation of the suite of products in an embodiment of the present invention.

FIG. 7A contains a graphical user interface, which enables users to specify additional configuration input parameter values which are used by the installation program in an embodiment of the present invention.

FIG. 7B illustrates a graphical user interface which displays values and status of pre-requisites which are verified by the program installing the suite of products in an embodiment of the present invention.

FIG. 7C contains a graphical user interface to display consolidated input values and values of the system parameters in an embodiment of the present invention.

FIG. 8 contains a graphical user interface showing the status of installation of the suite of products in an embodiment of the present invention.

FIGS. 9A and 9B together contain a text file containing various attributes associated input values which are stored by the installation program in an embodiment of the present invention.

FIGS. 10A and 10B together represent a XML file containing additional attributes which are accessed by the installation program in an embodiment of the present invention.

FIG. 11 contains a flow chart illustrating how installation can be resumed when the installation of a suite of products aborted in a previous installation attempt, according to an aspect of the present invention.

FIG. 12 is a block diagram illustrating an example embodiment in which various aspects of the present invention are operative when software instructions are executed.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

### 1. OVERVIEW

An installation wrapper provided according to an aspect of the present invention receives all the inputs required for installation of each software product (contained in a suite) at the start of installation, and all the software products are installed in a sequence without requiring additional inputs from the user. As a result, the products can potentially be installed without requiring additional user intervention once the installation of the first product starts. Such a feature is particularly important in situations in which installation of individual products can take a long time (since the user need not monitor/wait for completion of installation of each product to be able to provide the required inputs for the next product).

According to one more aspect of the present invention, the inputs provided by the user are stored on a non-volatile storage (e.g., in the form of one or more response files). In an embodiment, the input data corresponding to installation of each product is stored in a corresponding response file, and the application installing the corresponding product reads the data from the associated response file. As a result, each product can potentially be installed separately, for example, after aborting (voluntarily or involuntarily) the installation of the suite of products in the middle.

According to yet another aspect of the present invention, an application installing a product is designed to retrieve a flag from the command line (e.g., setup.exe—silent—response file), which indicates whether installation program should install the product with various default options (e.g., default set of modules/features within the product) and values specified in the response file. When the silent flag is not specified, user is requested to provide input values using the graphical user interface (which then controls the installation options for the corresponding product). By specifying the -silent option/flag and the location of the response file, the products can be installed using the parameters previously stored in the response files (and thus without requiring additional inputs from the user).

One more aspect of the present invention use the response files thus stored to resume installation of software products which were not installed, though part of a installation which was aborted prior to installation of such software products. Status information stored at a pre-specified location(s), may indicate the specific software products not yet installed, and the input values in the response files are used to install such not-yet-installed software products. Such a feature can be used, for example, when there is an unexpected abort in the middle of installation of a suite of software products.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. EXAMPLE ENVIRONMENT

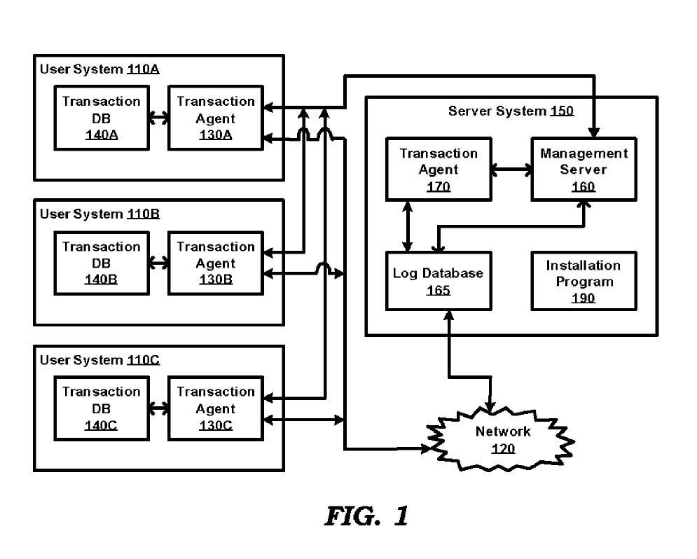

FIG. 1 is a block diagram illustrating an example environment in which various aspects of the present invention can be implemented. The environment is shown containing user systems 110A, 110B and 110C, network system 120 and server system 150. Only representative components (in number and kind) are shown for illustration, even though realistic systems generally contain many more systems. Each block of FIG. 1 is described below in further detail.

Network system 120 provides necessary network connectivity between various user systems and server system 150 implementing any one of the various well known protocols (e.g., TCP/IP on Ethernet). Each user system 110A, 110B and 110C is shown containing a transaction agent (130A, 130B and 130C respectively) and a transaction database (140A, 140B and 140C). Transaction databases contain the appropriate software and storage facilitating data to be organized, retrieved, and changed based on appropriate query languages (e.g., SQL in case of relational database).

Transaction agents 130A, 130B and 130C in each corresponding user system monitors various software products (including the transaction database) installed on the corresponding user system, and provide the corresponding metrics (e.g., resource utilization statistics, number of transactions processed, etc) to management server 160 according to a pre-specified protocol. For illustration, only one other software product (transaction database) is shown as being installed on each user/server system, however, many more software products can be installed on each of the systems.

Server system 150 is shown containing management server 160, transaction agent 170, log database 165 and installation program 190. Transaction agent 170, management server 160 and log database 165 represent corresponding software products sought to be installed according to various aspects of the present invention. Once installed, the products operate as described briefly below.

Log database 165 provides storage for various data such as the metrics data. Transaction agent 170 operates similar to each of transaction agents (130A, 130B and 130C), but monitors management server 160 and log database 165. The monitored metrics are again stored in log database 165.

Management server 160 receives metrics data from each transaction agent (130A, 130B and 130C), and stores the received data in log database 165. In an embodiment described below, metrics data is received only from transaction agents, which are authorized to send the data using a secure protocol.

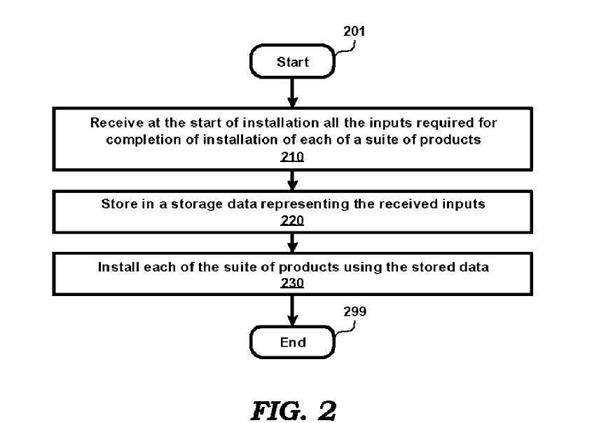

Installation program 190, when executed on severs system 150, installs the three-software products—management server 160, log database 165 and transaction agent 170. Various aspects of the present invention simplify installation of such suite of software products in user systems, as described below with respect to FIG. 2.

### 3. METHOD

FIG. 2 is a flowchart illustrating the manner in which a suite of products can be installed according to various aspects of the present invention. The flowchart is described with respect to FIG. 1 merely for illustration. However, the approach(es) can be implemented in other systems/environments as well. The flowchart begins in step 201, in which control passes to step 210.

In step 210, installation program 190 receives at the start of installation all the inputs (“user inputs”) required for completion of installation of each of a suite of products. In general, the inputs depend on the specific software products sought to be installed, and can be determined based on the manner in which each software product is designed to be installed and operated.

In step 220, installation program 190 may store in a storage, the data representing the received inputs. The data may be stored in a non-volatile storage (not shown in FIGS. 1 and 2), and then conveniently used to complete installation of each of the software products.

In step 230, installation program 190 installs each of the suite of products using the stored data. In situations in which the configuration data is available in non-volatile storage, as described in sections below, the corresponding data can be used to resume installation of software products, in case the installation was aborted in the middle earlier. Control then passes to step 299 where the program ends.

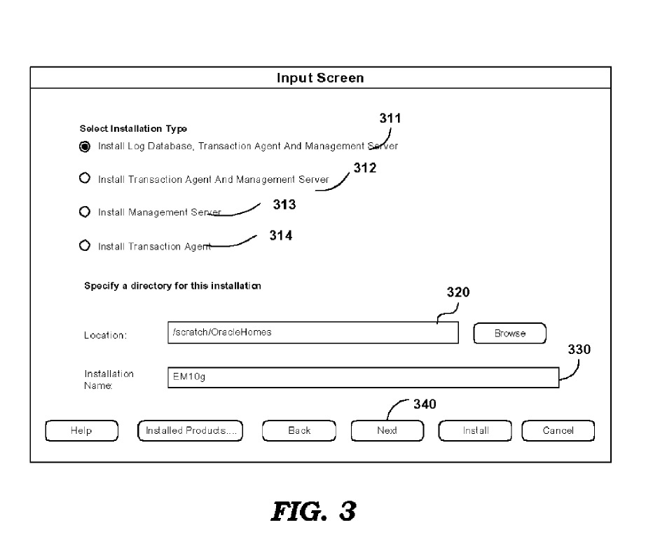

The description is continued with respect to the manner in which the approach of FIG. 2 can be used to install management server 160, log database 165 and transaction agent 170 of FIG. 1. In one embodiment, the instructions to install all the three software products and also to execute installation program 190 is provided in a computer readable medium (such as a compact disk(s)). Installation program 190 is executed to start the installation of the desired products and the user may provide the corresponding inputs as described below with respect to FIG. 3.

### 4. RECEIVING INPUTS

FIGS. 3-6 and FIG. 7A contain screens representing an example user interface which facilitates users to identify various software products which need to be installed, and to provide input values and configuration values needed for completing installation of the products. The input values may contain (global) parameters used generally for installation, as well as the specific configuration values required for completing installation of each product sought to be installed.

FIG. 3 illustrates the manner in which a user can specify the desired set of software products to be installed, as well as the directory in which the installations have to occur. User selects one of the four control buttons 311-314 to indicate the specific set of software products to be installed. Control buttons 311-314 respectively correspond to the sets {management server 160, log database 165 and transaction agent 170}, {management server 160 and transaction agent 170}, {management server 160}, and {transaction agent 170}.

Input value in text control 320 indicates the high-level directory (on server system 150) at which the software products will be installed. A name is also being assigned to the installation in text input control 330, and is used for logging and later for any necessary resumption of installation, as described in sections below.

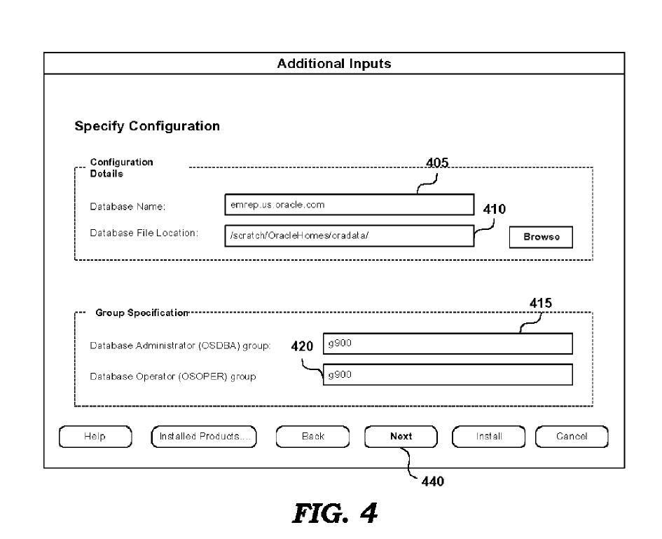

For illustration, the user is assumed to have selected control button 311, and therefore the remaining screens of FIGS. 4-6 illustrate the remaining specific input values received from a user to complete installation of the selected software products. Control may transfer to the screen of FIG. 4 when a user selects the next button 340.

FIG. 4 depicts a screen, which facilitates users to provide inputs required for the installation of log database 165. As may be appreciated, text control 405 indicates a name of log database 165 sought to be installed, and text control 410 indicates the identifier/name of a file in which the data corresponding to (or representing the content of) log database 165 is stored.

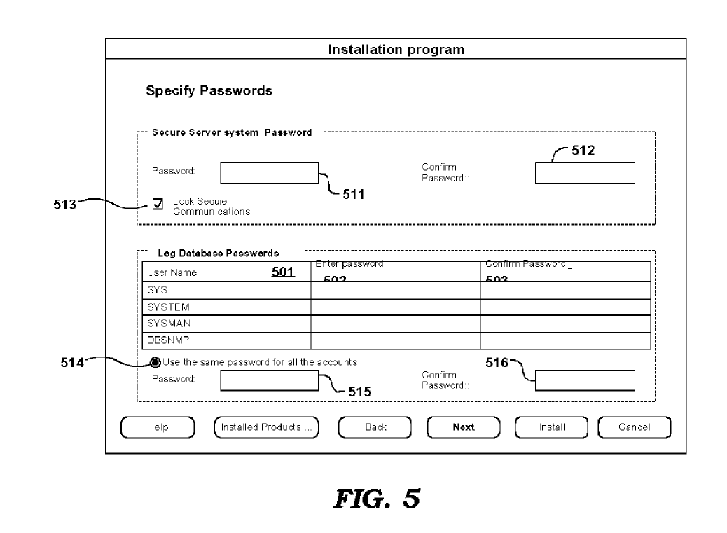

Text controls 415 and 420 respectively indicate the authorization parameters needed for installing log database 165 in the example Unix platform in which various aspects of the present invention are implemented. In such a system, creation of a database requires SYSDBA and SYSOPER privileges, and the inputs in text controls 415 and 420 identify the Unix (privileged) Groups of which the person installing the software is a member. Control transfers to the screen of FIG. 5 when the user selects next button 440. In an embodiment implemented in the context of Unix Environment, user accounts SYSDBA and SYSOPER are groups that have the privilege to create the database. These groups are created by default when the database software is installed.

Continuing with the description of inputs required for installation, FIG. 5 contains text controls for receiving the password information (for authentication) for various user identifiers (SYS, SYSTEM, SYSMAN and DBSNMP) in log database 165 sought to be created as indicated by the controls 501, 502 and 503. Alternatively, user may provide a single password (as in text controls 515 and 516) for the users identified as SYS, SYSTEM, SYSMAN and DBSNMP by selecting 514.

The user identifiers created above in log database 160 are used by other software products installed on server system 150 such as management server 160 to access/store and maintain data in log database 165.

Text control 511 and 512 indicate user identifier/password combinations used for secure communication from each transaction agents 130A, 130B and 130C to management server 160. The same value provided in text controls 511 and 512 may need to be provided during installation of transaction agent on each of the user systems (110A, 110B and 110C), so that it can communicate with the management server 160.

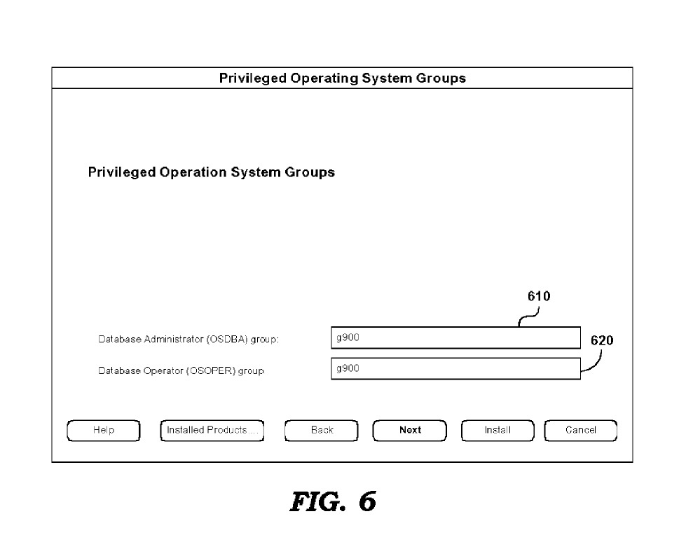

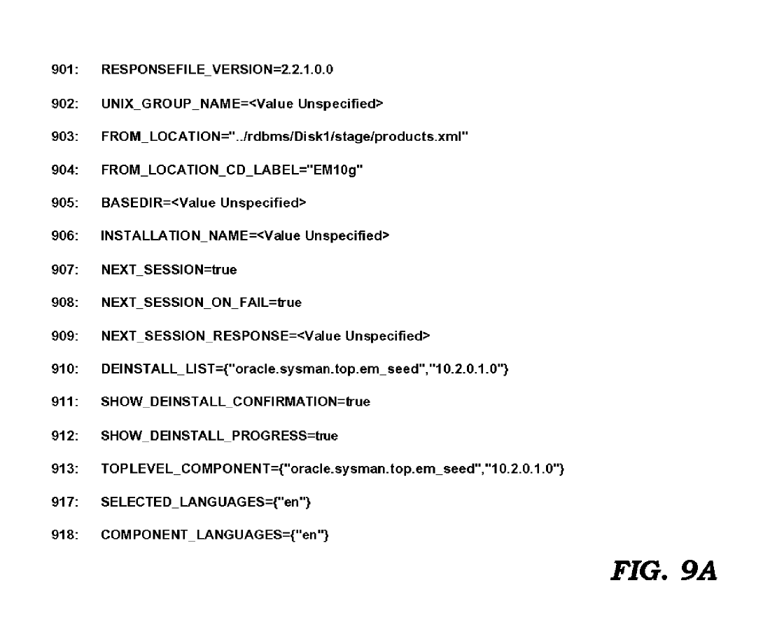

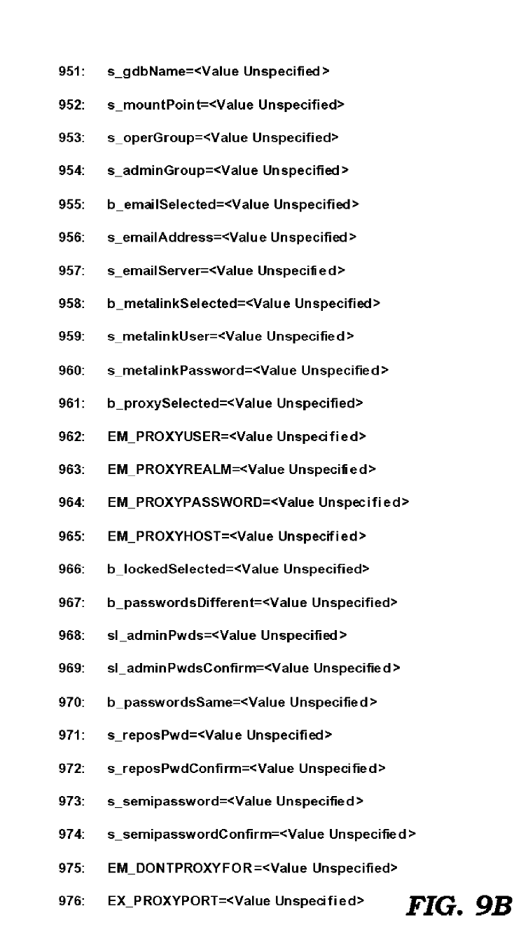

FIG. 6 contains additional text controls 610 and 620 to enable a user to provide additional authorization parameters (stored later respectively in lines 954 and 953 of FIG. 9B) required for accessing server system 150 to update log database 165. The data there indicates that the person installing the suite of products is a part of g900 group.

The input values thus received in various text controls are stored in a data storage. In an embodiment, input values are stored in text files (as response files) described in an embodiment in sections below with reference to FIGS. 9A and 9B.

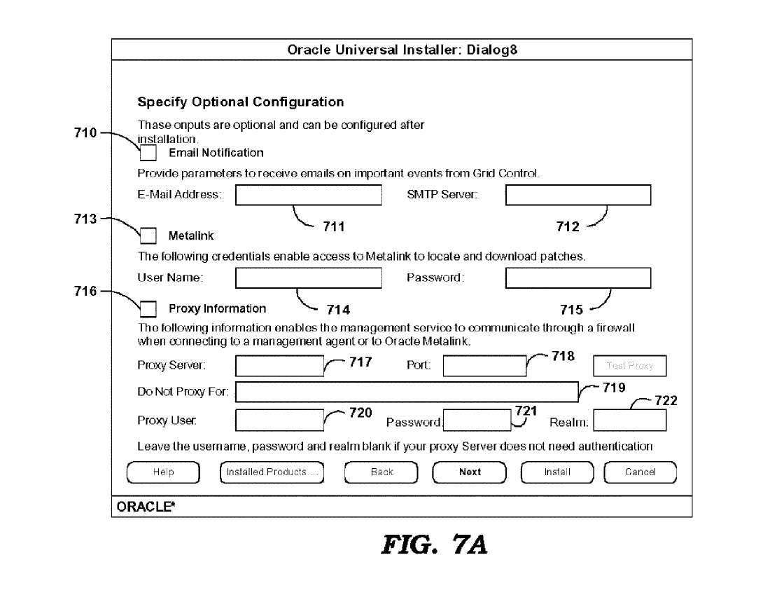

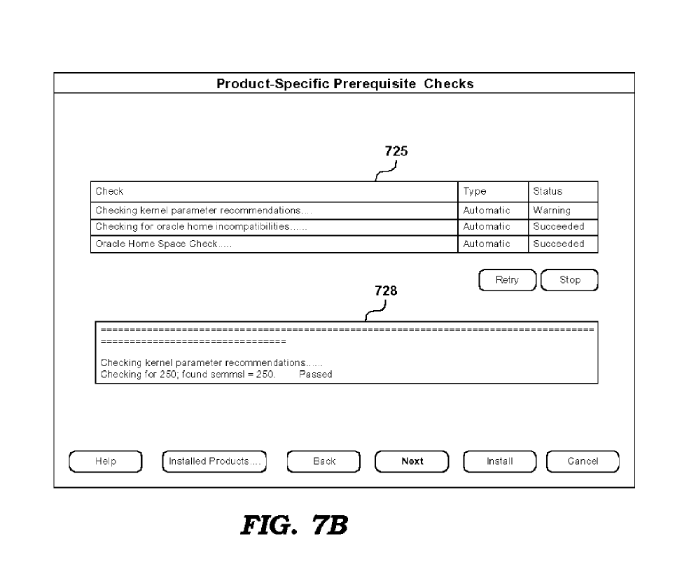

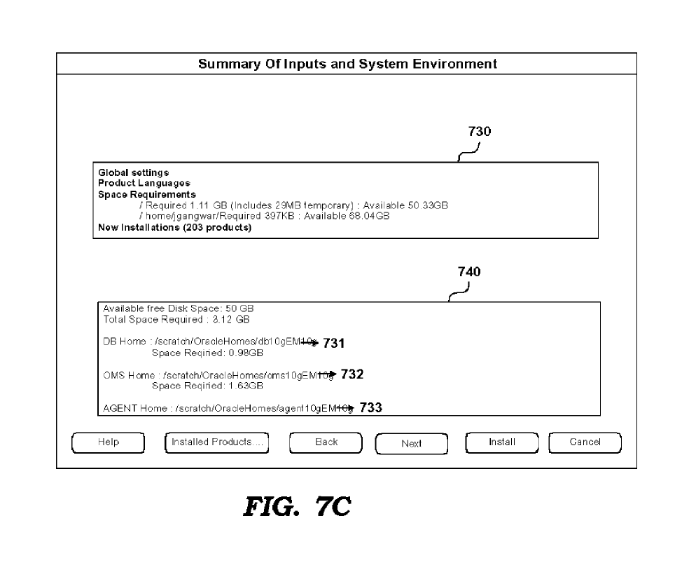

FIG. 7A contains text controls to enable a user to provide any configuration parameters (which may be stored in the response files). Controls 710, 713 and 716, when selected enable users to provide values in corresponding text controls {711, 712}, {714, 715} and {717, 718, 719, 720, 721}.

Text controls 711 and 712 indicate text controls to enable user to provide the e-mail addresses of the users to be notified and the e-mail server through which e-mails are to be routed. The values selected for control 710 and the values entered in text controls 711 and 712 are later stored in the response file as indicated by lines 955-957 respectively.

Text controls 714 and 715 enable users to provide logon credentials for the user systems to access a server containing data indicating any patches/upgrade to any of the programs installed on the user system accessing the server. The corresponding values of controls 713, 714 and 715 are stored in lines 958-960 respectively.

Text controls 717-722 enable users to specify data that enables the management service 160 to communicate through a firewall when connecting to a management agent 130 (assuming it is a behind a firewall) or to meta-link server. The values entered by the users in the controls 716, 717 and 718 are stored in response files corresponding to lines 961, 962 respectively. Similarly, values entered in controls 719 are stored EM_DONTPROXYFOR of the response file, as described later). When this value is set, the domains should not use proxy access. Values in text controls 720-722 are stored in 962, 964 and 963 respectively.

Installation manager 190 may proceed with installation of the software products based on the received inputs above, on server system 150. The description is continued with how installation manager 190 performs additional validations on server system 150 prior to installation of the software products.

### 5. INSTALLATION

FIG. 7B indicates additional validations performed by installation program 190 on server system 150 depending on the required installation environment for completing installation of the set of software products, prior to starting of installation.

Display section 725 indicates specific additional validations performed for installation of the three products on server 150. Similarly, display section 728 indicates any warnings and corresponding actions a user may perform, when installation program 190 detects that server system 150 does not provide the desired environment. FIG. 7C indicates a summary of the installation environment such as hardware storage space required for the installation of the product (730), available hardware storage on server system 150 (740). Lines 731, 732 and 732 respectively indicate corresponding directory locations in which log database 165, management server 160 and transaction agent 170 will be installed.

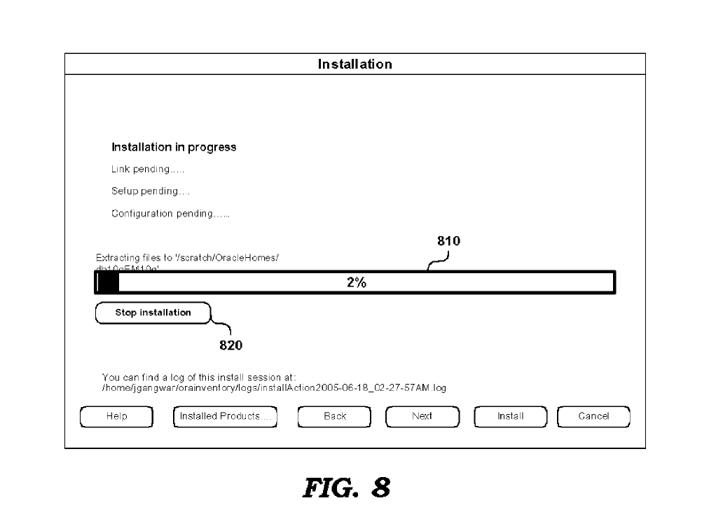

Installation program 190 begins installation of the products, when it determines that server system 150 has all the necessary resources (e.g., disk space) for completion of installation of the set of products. FIG. 8 contains a graphical user interface which display progress of installation of the suite of products in an embodiment of the present invention.

Display section 810 indicates progress of installation. When the user clicks on control ‘Stop Installation’ (820), the execution of the installation program may be terminated. Installation program 190 may store in various attributes, values associated with the name of the products in the suite that are installed and location of the installed products in server system 150. Additionally, installation program 190 may also store values in additional attributes as illustrated below in an embodiment of the present invention.

It may be appreciated that all the three software products log database 165, management server 160 and transaction agent 170, are installed sequentially without requiring user intervention since the data required for all the three products is received once prior to the start of the installation of the first software product. The parameters used are summarized below:

All products: 320, 330, 610 and 620

log database 165: 405, 410, 415, 420, 502, 503, 514, 515, 516

Management server 160: 511, 512, 513, 502, 503, 514, 515, 516

transaction agent 170: 511, 512, 513

In an embodiment, attributes associated with installation of suite of products are stored in a text file. However, the attributes can be stored in other forms (binary, XML, etc.) as well without departing from the scope and spirit of various aspects of the present invention. The description is continued with an illustration of contents of a response file for the installation of log database 165.

### 6. RESPONSE FILES

FIGS. 9A and 9B together illustrate the manner in which the user provided input values are stored in a response file in an embodiment of the present invention. The content of the response file is generated based on the various inputs provided by the user. Only relevant portions of the text file for implementation of various aspects of the present invention are described for conciseness.

Lines 901-904 are shown containing attributes, which contain corresponding pre-determined values. As may be appreciated from the labels of the attributes, line 902 indicate the user group (of the identifier with which the user has logged to perform installation), and is used for determining the access restrictions on the system.

Line 903 and 904 contain values corresponding to the identifiers of the disk location from where the installation program for installing the suite of products can be accessed. Line 905 contains a value indicating the specific directory location in which the installed software is stored. Line 906 contains a value indicating the name of the present installation.

Line 907 through 909 indicates parameters used for installations of a suite of products. Installation program 190, after completing the installation of a product in the suite of products may verify the value contained in “NEXT_SESSION_RESPONSE” to determine the location of the response file to install the subsequent product to install in the suite of products. Typically, when there are no other products to install after the installation of the present product in the suite of products, the value of “NEXT_SESSION” is set to false.

These parameters are used for chaining two installations. At the end of each installation, the installer checks the values of these parameters to find out if another product need to be installed. NEXT_SESSION_RESPONSE indicates the location of the response file to be used for the next installation. The last product in the suite will have NEXT_SESSION=false in its response file.

Line 910 is shown containing a value {“oracle.sysma.top.em_seed”, “10.2.0.1.0”} for the attribute “DEINSTALL_LIST” indicating the list of the products in the suite of products, which can be de-installed if desired. The value can be determined by the selection of the suite of products as indicated by the radio button controls 311-314. Lines 911 and 912 contain corresponding values stored in variables “SHOW_DEINSTALL_CONFIRMATION” and “SHOW_DEINSTALL_PROGRESS” indicating whether additional user inputs are needed to proceed with de-installation of the suite of products and whether the progress during de-installation should be displayed respectively.

Line 913 contains a value in attribute “TOPLEVEL_COMPONENT” according to the selection of radio button controls 311-314 indicating the products in the suite of products that are sought to be installed. The value of the TOPLEVEL_COMPONENT is set as “oracle.sysman.top.em_seed”, when either of the radio button controls 311 and 312 is selected. Similarly, the value of TOPLEVEL_COMPONENT is defined as “oracle.sysman.top.oms”, “oracle.sysman.top.agent” when radio button control 313 or 314 is selected respectively.

Lines 917 and 918 contain attributes indicating the language of preference as “en” (English). The values which are entered by users installing the product in controls 405, 410, 420 and 415 are respectively stored in attributes “s_dbname”, “s_mountpoint”, “s_operGroup”, “s_adminGroup” as indicated in lines 951-954.

Lines 955-957 contain attributes for storing corresponding details (in controls 710, 711, 712) indicating whether an e-mail notification can be sent, e-mail address of user to notify, e-mail server on installation.

Lines 958-960 contain attributes for storing corresponding values entered in controls 713, 714 and 715 respectively. Lines 961-965, 975-976 contain attributes to store corresponding values entered/selected for controls 716, 720, 722, 721, 717, 719, 718 respectively.

Lines 966-972 respectively contain attributes to store inputs received in controls 513, 514, 502, 503, 514, 515 and 516. Similarly, lines 973 and 974 respectively contain attributes to store input values received in controls 511 and 512 respectively.

Additional text files may be created to store any additional parameters corresponding to location of the text file (of FIGS. 9A and 9B) are generated during the installation of the suite of products. The description is continued with an illustration of the additional attributes which are stored in an embodiment of the present invention.

### 7. ADDITIONAL ATTRIBUTES

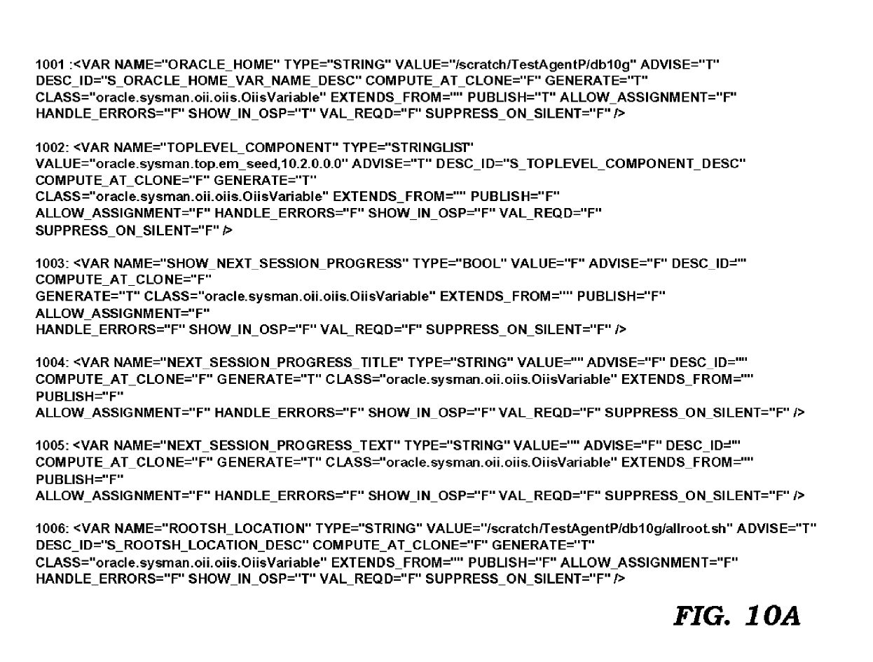

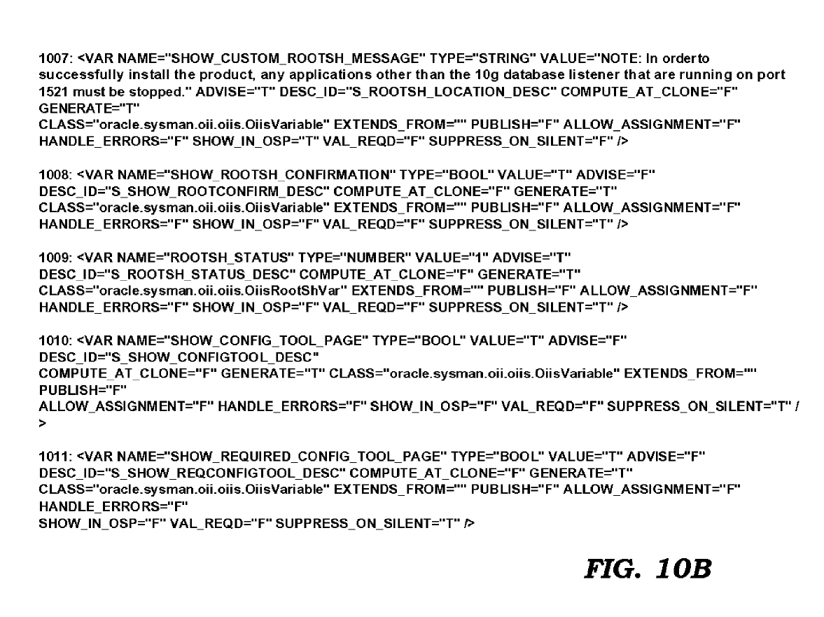

FIGS. 10A and 10B together indicate a text file containing attributes in addition to the attributes stored in the response file. The file is shown containing attributes using Extended Markup Language (XML). The attributes are described briefly below.

Lines 1001 and 1002 contain attributes (“ORACLE_HOME”, and “TOPLEVEL_COMPONENT”) indicating the location and the products which have been installed. For example, value “oracle.sysman.top.em_seed, 10.2.0.0.0” for the attribute “TOPLEVEL_COMPONENT” (1002) indicates the product installed in the directory corresponding to the value “/scratch/TestAgentP/db10g” for the attribute “ORACLE_HOME. (1001)

Lines 1003, 1004 and 1005 contain attributes “SHOW_NEXT_SESSION_PROGRESS”, “NEXT_SESSION_PROGRESS_TITLE”, “NEXT_SESSION_PROGRESS_TEXT”). These parameters determine whether a status bar corresponding to preinstall setup is to be displayed between the time period between installation of products in a suite of products.

Installation program 190 checks the contents of the file present in the user's home directory to decide whether to perform a fresh install of the suite of products or to resume installation of a product in the suite of products. The command lines below are respectively executed to install a suite of products with user inputs/using the response file or to resume installation of suite of products:

<OUI Location>/runinstaller-silent-responseFile<firstOH>/install/chaininstall/<response file name>-globalcontextxml<firstOH>/install/chaininstall/globalcontext.xml.

Command ‘runinstaller’ (in Unix environment and setup in Microsoft's Windows environment) in the location identified by the parameter <OUI Location> corresponds to installation program 190. When executed, the installation may be started. The text file (<firstOH>/install/chaininstall/globalcontext.xml.) is updated when each of the products in the suite of products is successfully installed.

User may provide values in the corresponding user input screens (FIGS. 3-6, 7A-7B) during the installation. Installation program 190 may store the values thus provided in a response file at a location corresponding to the value of parameter <location of responsefile>.

<OUI Location>/runinstaller-record-destinationfile<location of response file>

Specifying ‘-silent’ and the location of the response file performs installation of the suite of products without accepting input values (in FIGS. 3-6, 7A-7B). The values required for the installation are contained in (and thus retrieved from) the response file. Installation Program 190 may implement necessary program logic to determine the location of the response file. For example, the location corresponding to the parameter specified earlier with ‘-destinationfile’ could be stored in nonvolatile storage according to a pre-specified convention (e.g., in pre-specified directories and with a pre-specified name for the file containing the identifier of the destination file) and later could be accessed for determination of the location of response file.

Line 1006 contains an attribute “ROOTSH_LOCATION”, which stores the value of the storage location of a text file containing command lines (script file). Installation program 190 displays the file identifier and location of the script file, which can be run to perform additional configuration to complete the installation.

Line 1007 contains attribute “SHOW_CUSTOM_ROOTSH_MESSAGE”, which stores a text value indicating any message (product specific message), which will be displayed while executing the text file stored in the location determined by line 1006.

Line 1008 contains an attribute “SHOW_ROOTSH_CONFIRMATION”, which contains a value indicating whether the rootsh screen should be displayed or not. Installation program 190 waits for a user input before proceeding with the installation by the execution of the text file stored in the location determined by line 1006.

Line 1009 contains an attribute “ROOTSH_STATUS”, which stores a value indicating whether the dialog will be shown before or after the configuration tools screen.

Lines 1010 and 1011 contain attributes “SHOW_CONFIG_TOOL_PAGE”, “SHOW_REQUIRED_CONFIG_TOOL_PAGE” respectively, determining the display of configuration screens at the end of installation of all the products in the suite or execute them in a non-interactive mode.

As may be appreciated, the user may select ‘Stop installation’ 820, to terminate the present installation of the suite of products. Installation program 190 would have stored the information about the previous (completed) installations in the globalcontex.xml file. This information contains the location of the responsefile for the current installation (that is being terminated). So the globalcontext.xml file along with the response files provides data, which may be used for later installation of the suite of products or recovery of the present installation.

The description is continued with an illustration of how installations, which are terminated, can be recovered based on the attributes stored above.

### 8. RESUMING INSTALLATIONS

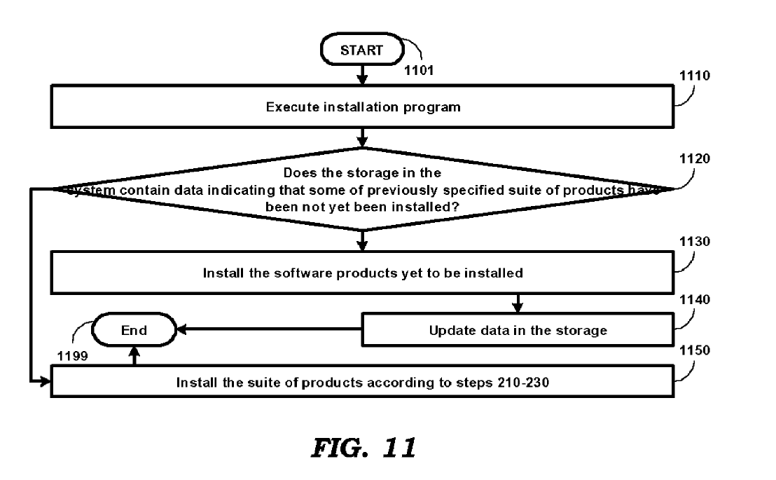

FIG. 11 is a flowchart illustrating the manner in which an installation of a suite of products is completed automatically even if the installation has aborted previously in the middle. That is, assuming a user specified installation of three software products and the installation of only one product is completed and the installation aborted, a feature of the invention resumes the installation to install only the two remaining software products when the user initiates execution of installation program 190. The flowchart begins in step 1101, in which control passes to step 1110.

In step 1110, a user executes installation program 190. In step 1120, installation program 190 determines whether the (nonvolatile) storage in the system contains data indicating that some of the software products present in this suite of products are already installed. Control passes to step 1130 if there are any such products, else to step 1150. In an embodiment, determination can be done by accessing the value of the variables ORACLE_HOME of line 1001 “TOPLEVEL_COMPONENT” of line 1002 indicating products in the suite, which have been already installed. The lines 1001 and 1002 indicate that oracle.sysman.top.em_seed version 10.2.0.0.0 is installed in the directory “/scratch/TestAgentP/db10g”.

In step 1130, the software products determined in step 1120 are installed. In an embodiment of the present invention, the value stored for the attributes “ORACLE_HOME” (In line 1001) are accessed to determine the location of the text file, which can be executed to begin the installation.

Values of the attributes containing input values provided by the user during prior installation are accessed during execution of the installation program 190 (values available through globalcontext.xml file), there by resuming installation of the suite of products.

Additional values stored in attributes “ROOTSH_STATUS” (1009), SHOW_CONFIG_TOOL_PAGE (1010) and “SHOW_REQUIRED_CONFIG_TOOL_PAGE” (1011) can be accessed and depending on the values contained, the status/progress in installation and a user interface to allow configuration of the other products are displayed.

Continuing with the illustration of resuming installation, in 1140, data in the storage is updated to reflect completion of installation of each product in the suite of products and control passes to step 1199, where the program ends.

In step 1150, installation program 190 installs the suite of products according to steps 210-230. Once the installation of the suite is completed, program control passes to step 1199, where the program ends.

It should be understood that the features described above can be implemented using a desired combination of hardware, software and firmware, as suited for a specific situation. The description is continued with respect to an embodiment in which various features are operative by execution of software instructions in a digital computer system.

### 9. DIGITAL PROCESSING SYSTEM

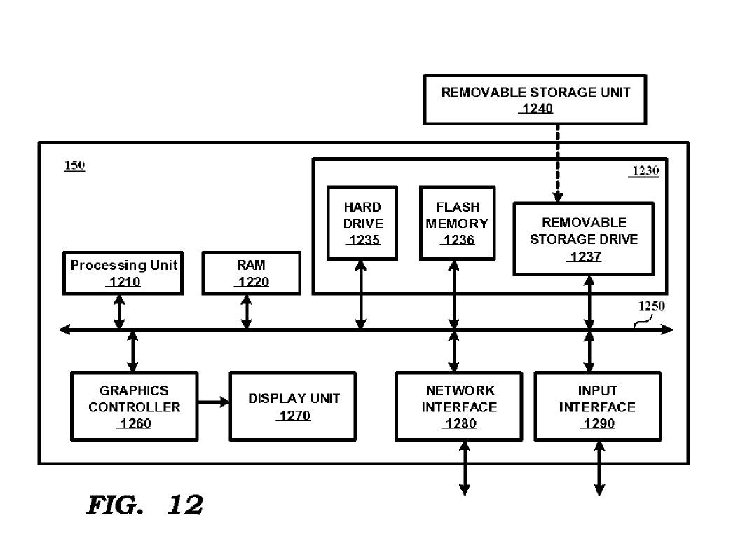

FIG. 12 is a block diagram illustrating the details of digital processing system 1200 in which various aspects of the present invention are operative by execution of appropriate software instructions. System 1200 may correspond to server system 150. System 1200 may contain one or more processors such as central processing unit (CPU) 1210, random access memory (RAM) 1220, secondary memory 1230, graphics controller 1260, display unit 1270, network interface 1280, and input interface 1290. All the components except display unit 1270 may communicate with each other over communication path 1250, which may contain several buses as is well known in the relevant arts. The components of FIG. 12 are described below in further detail.

CPU 1210 may execute instructions stored in RAM 1220 to provide several features of the present invention. CPU 1210 may contain multiple processing units, with each processing unit potentially being designed for a specific task. Alternatively, CPU 1210 may contain only a single general purpose processing unit. RAM 1220 may receive instructions from secondary memory 1230 using communication path 1250.

Graphics controller 1260 generates display signals (e.g., in RGB format) to display unit 1270 based on data/instructions received from CPU 1210. Display unit 1270 contains a display screen to display the images defined by the display signals. Input interface 1290 may correspond to a key-board and/or mouse. Graphics controller 1260, display unit 1270 and input interface 1290 together provide a suitable interface (e.g., as shown in the display screens described above) for a user to perform installations according to various features of the present invention. Network interface 1280 provides connectivity to a network (e.g., using Internet Protocol), and may be used to communicate with the other systems of FIG. 1.

Secondary memory 1230 may contain hard drive 1235, flash memory 1236 and removable storage drive 1237. Secondary memory 1230 may store the data and software instructions (e.g., methods instantiated by each of client system), which enable system 1200 to provide several features in accordance with the present invention. Some or all of the data and instructions may be provided on removable storage unit 1240, and the data and instructions may be read and provided by removable storage drive 1237 to CPU 1210. Floppy drive, magnetic tape drive, CD-ROM drive, DVD Drive, Flash memory, removable memory chip (PCMCIA Card, EPROM) are examples of such removable storage drive 1237.

Removable storage unit 1240 may be implemented using medium and storage format compatible with removable storage drive 1237 such that removable storage drive 1237 can read the data and instructions. Thus, removable storage unit 1240 includes a computer readable storage medium having stored therein computer software and/or data.

In this document, the term “computer program product” is used to generally refer to removable storage unit 1240 or hard disk installed in hard drive 1235. These computer program products are means for providing software to system 1200. CPU 1210 may retrieve the software instructions, and execute the instructions to provide various features of the present invention described above.

### 10. CONCLUSION

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system and a data warehouse system.

What is claimed is:

1. A method of simplifying installation of a suite of software products, said method being performed in a system, said method comprising:
receiving from a first set of input data required to install a first software product and a second set of data specifically required to install a second software product, wherein said first software product and said second software product are contained in said suite of software products, wherein said first set of input data is not identical to said second set of input data; and
installing said first software product using said first set of input data and then said second software product using said second set of input data,
wherein said installing is performed after said receiving,
whereby both of said first software product and said second software product can be installed without requiring additional user intervention due to said receiving being performed before said installing.

2. The method of claim 1, further comprising storing said first set of data and said second set of data in a secondary storage in the form of one or more files.

3. The method of claim 2, further comprising:
checking whether any of said suite of products specified in a previous installation are not yet installed,
wherein said checking indicates that a third software product is contained in said any of said suite of products; and
installing said third software product based on a third set of input data provided by said user and also stored by said storing.

4. The method of claim 2, further comprising:
providing said one or more files as inputs to an installation program on another system, wherein said installation program retrieves said first set of input data and said second set of input data to install said first software product and said second software product on said another system.

5. The method of claim 4, wherein said installation program uses said one or more files for installing said first software product and said second software product upon receiving a parameter in a command line executing said installation program, wherein said installation program interactively receives said first set of input data and said second set of input data otherwise.

6. A computer readable medium carrying one or more sequences of instructions causing installation of a suite of software products simplified, wherein execution of said one or more sequences of instructions by one or more processors contained in said database server causes said one or more processors to perform the actions of:
receiving from a first set of input data required to install a first software product and a second set of data specifically required to install a second software product, wherein said first software product and said second software product are contained in said suite of software products, wherein said first set of input data is not identical to said second set of input data; and
installing said first software product using said first set of input data and then said second software product using said second set of input data,
wherein said installing is performed after said receiving,
whereby both of said first software product and said second software product can be installed without requiring additional user intervention due to said receiving being performed before said installing.

7. The computer readable medium of claim 6, further comprising storing said first set of data and said second set of data in a secondary storage in the form of one or more files.

8. The computer readable medium of claim 7, further comprising:
checking whether any of said suite of products specified in a previous installation are not yet installed,
wherein said checking indicates that a third software product is contained in said any of said suite of products; and
installing said third software product based on a third set of input data provided by said user and also stored by said storing.

9. The computer readable medium of claim 7, further comprising:
providing said one or more files as inputs to an installation program on another system, wherein said installation program retrieves said first set of input data and said second set of input data to install said first software product and said second software product on said another system.

10. The computer readable medium of claim 9, wherein said installation program uses said one or more files for installing said first software product and said second software product upon receiving a parameter in a command line executing said installation program, wherein said installation program interactively receives said first set of input data and said second set of input data otherwise.

11. An article of manufacture simplifying installation of a suite of software products in a system, said article of manufacture comprising:
means for receiving from a first set of input data required to install a first software product and a second set of data specifically required to install a second software product, wherein said first software product and said second software product are contained in said suite of software products, wherein said first set of input data is not identical to said second set of input data; and
means for installing said first software product using said first set of input data and then said second software product using said second set of input data,
wherein said installing is performed after said receiving,
whereby both of said first software product and said second software product can be installed without requiring additional user intervention due to said receiving being performed before said installing.

12. The article of manufacture of claim 11, further comprising means for storing said first set of data and said second set of data in a secondary storage in the form of one or more files.

13. The article of manufacture of claim 12, further comprising:
means for checking whether any of said suite of products specified in a previous installation are not yet installed,
wherein said means for checking indicates that a third software product is contained in said any of said suite of products; and
means for installing said third software product based on a third set of input data provided by said user and also stored by said storing.

14. The article of manufacture of claim 12, further comprising:
means for providing said one or more files as inputs to an installation program on another system, wherein said installation program retrieves said first set of input data and said second set of input data to install said first software product and said second software product on said another system.

15. The article of manufacture of claim 14, wherein said installation program uses said one or more files for installing said first software product and said second software product upon receiving a parameter in a command line executing said installation program, wherein said installation program interactively receives said first set of input data and said second set of input data otherwise.
